(19) United States
(12) Patent Application Publication
(10) Pub. No.: US 2025/0128565 A1
(43) Pub. Date: Apr. 24, 2025

(54) STABILIZER BUSHING

(71) Applicants: SUMITOMO RIKO COMPANY LIMITED, Komaki-shi (JP); TOYOTA JIDOSHA KABUSHIKI KAISHA, Toyota-shi (JP)

(72) Inventors: Takahisa KATO, Komaki-shi (JP); Shosuke YACHIDA, Toyota-shi (JP)

(73) Assignees: SUMITOMO RIKO COMPANY LIMITED, Komaki-shi (JP); TOYOTA JIDOSHA KABUSHIKI KAISHA, Toyota-shi (JP)

(21) Appl. No.: 18/917,025

(22) Filed: Oct. 16, 2024

(30) Foreign Application Priority Data
Oct. 18, 2023 (JP) 2023-179858

(51) Int. Cl. B60G 21/055

(52) U.S. Cl. CPC B60G 21/0551; B60G 2204/41; B60G 2204/43

(57) ABSTRACT

A stabilizer bushing for elastically holding a stabilizer bar in position in a vehicle and including a bushing body made of a tubular elastic body. The bushing body includes a linear portion on an inner circumferential surface. The linear portion is to be in close contact with an outer circumferential surface of the stabilizer bar. A rigid pedestal member is arranged in an attachment-side portion of the bushing body. The attachment-side portion is to be attached to a vehicle body side. An inside surface of the pedestal member that is in close contact with the bushing body includes an axial convex surface protruding gradually inward from both axial ends toward an axial center across an entire axial length in a portion located on a radially outer side of the linear portion, and a circumferential concave surface curving in a circumferential direction.

### INCORPORATED BY REFERENCE

The disclosure of Japanese Patent Application No. 2023-179858 filed on Oct. 18, 2023 including the specification, drawings and abstract is incorporated herein by reference in its entirety.

### BACKGROUND ART

### 1. Technical Field

The present disclosure relates to a stabilizer bushing for use in an automobile and the like.

### 2. Description of the Related Art

Conventionally, a stabilizer bushing has been used to support a stabilizer bar on a vehicle body side. As shown in U.S. Publication No. US 2017/0080772 A1, for example, such stabilizer bushing includes a bushing body made of an elastic body of approximately tubular shape overall, and is externally mounted onto the stabilizer bar. Meanwhile, a band plate-shaped bracket, which is overlapped on the outer peripheral surface of the stabilizer bushing, is attached to the vehicle body. By so doing, the stabilizer bushing elastically holds the stabilizer bar in position with respect to the vehicle body.

### SUMMARY

Meanwhile, in the stabilizer bushing, for example, when improvement of durability is required, it is generally considered to respond by increasing the rubber hardness.

However, if the rubber hardness is increased, the spring characteristics in the prizing direction or the like input during driving may become harder, which may adversely affect, for example, ride comfort or the like. In particular, for the purpose of adjusting the support position of the stabilizer bar and improving the stability of the support position, a pedestal member for attachment may be assembled on the vehicle body side of the bushing body. In this case, the presence of the pedestal member is likely to make the spring characteristics in the prizing direction or the like even harder, and there is another problem that the concentration of elastic strain may make it even more difficult to ensure durability.

It is therefore one object of the present disclosure to provide a stabilizer bushing of novel structure which is able to stably hold a stabilizer bar in position by adopting a pedestal member, and to achieve improvement in durability while preventing the spring characteristics in the prizing direction from excessively becoming harder.

Hereinafter, preferred embodiments for grasping the present disclosure will be described. However, each preferred embodiment described below is exemplary and can be appropriately combined with each other. Besides, a plurality of elements described in each preferred embodiment can be recognized and adopted as independently as possible, or can also be appropriately combined with any element described in other preferred embodiments. By so doing, in the present disclosure, various other preferred embodiments can be realized without being limited to those described below.

A first preferred embodiment provides a stabilizer bushing configured to elastically hold a stabilizer bar in position in a vehicle, comprising: a bushing body comprising a tubular elastic body, the bushing body including a linear portion on an inner circumferential surface, the linear portion being configured to be in close contact with an outer circumferential surface of the stabilizer bar; and a rigid pedestal member arranged in an attachment-side portion of the bushing body, the attachment-side portion being configured to be attached to a vehicle body side, wherein an inside surface of the rigid pedestal member that is in close contact with the bushing body comprises: an axial convex surface protruding gradually inward from both axial ends toward an axial center across an entire axial length in a portion located on a radially outer side of the linear portion; and a circumferential concave surface curving in a circumferential direction.

According to the stabilizer bushing structured following the present preferred embodiment, it is possible to adjust the spring characteristics in each direction by means of the pedestal member, thereby achieving the required performance to a higher degree. That is, the axial convex surface is set on the inside surface of the pedestal member, so that the thickness dimension of the bushing body between the opposed stabilizer bar and pedestal member is set small in the axially center portion. Accordingly, in the direction in which the pedestal member and the stabilizer bar are arranged side by side, hard spring characteristics will be achieved by the protrusion of the axial convex surface. This makes it possible to stably hold the stabilizer bar in position and to improve durability by preventing excessive deformation of the bushing body.

Furthermore, the thickness dimension between the stabilizer bar and the pedestal member at both axial ends of the bushing body is largely obtained by the change in the inward protruding dimension of the axial convex surface. Therefore, soft spring characteristics with respect to displacement of the stabilizer bar in the prizing direction are achieved, thereby providing a good ride comfort of the vehicle.

Besides, the circumferential concave surface is set on the inside surface of the pedestal member, so that both end portions of the circumferential concave surface contribute to hard spring characteristics in the direction in which the stabilizer bar and the pedestal member are arranged side by side. Moreover, the circumferential concave surface makes it possible to prevent the bushing body, which is located between the stabilizer bar and the pedestal member, from being locally thin-walled, thereby achieving a good ride comfort and the like due to soft spring characteristics with respect to torsional displacement of the stabilizer bar.

A second preferred embodiment provides the stabilizer bushing according to the first preferred embodiment, wherein the axial convex surface protrudes with a shape that gradually curves inward toward the axial center from portions located on the radially outer side of both axial ends of the linear portion of the bushing body, and the axial convex surface includes a straight portion at an axially center portion, the straight portion extending in an axial direction with a constant protrusion height.

According to the stabilizer bushing structured following the present preferred embodiment, owing to the straight portion set at the axially center portion of the pedestal portion, stabilization of the mounted state onto the stabilizer bar will be achieved. In addition, the bushing body between the stabilizer bar and the pedestal member is thin-walled within a predetermined length in the axial direction where the straight portion is provided. This makes it easy to set an axis-perpendicular spring hard in the direction in which the stabilizer bar and the pedestal member are arranged side by side, while achieving soft spring characteristics with respect to input in the prizing direction.

A third preferred embodiment provides the stabilizer bushing according to the second preferred embodiment, wherein an axial length of the straight portion is set within a range of 1/10 to ½ of that of the linear portion.

According to the stabilizer bushing structured following the present preferred embodiment, by providing the straight portion, it is possible to compatibly achieve hard spring characteristics in the axis-perpendicular direction and soft spring characteristics in the prizing direction in a good balance.

A fourth preferred embodiment provides the stabilizer bushing according to any one of the first through third preferred embodiments, wherein the bushing body has a configuration of two divided sections comprising: the attachment-side portion configured to be attached to the vehicle body side; and an opposite-side portion arranged opposite to and overlapped with the attachment-side portion in an axis-perpendicular direction.

According to the stabilizer bushing structured following the present preferred embodiment, the attachment-side portion in which the pedestal member is arranged while being configured to be attached to the vehicle body side, and the opposite-side portion arranged opposite to the attachment-side portion, are formed independently of each other. With this configuration, formability of the bushing body can be improved, and mounting onto the stabilizer bar can be facilitated.

A fifth preferred embodiment provides the stabilizer bushing according to any one of the first through fourth preferred embodiments, wherein the linear portion of the inner circumferential surface of the bushing body comprises a fastening surface configured to be fastened to the stabilizer bar.

According to the stabilizer bushing structured following the present preferred embodiment, a stable mounting of the stabilizer bushing onto the stabilizer bar is realized by the linear portion of the inner circumferential surface of the bushing body being fastened to the stabilizer bar.

A sixth preferred embodiment provides the stabilizer bushing according to any one of the first through fifth preferred embodiments, wherein the inner circumferential surface of the bushing body includes diameter-enlarged parts on both axial sides of the linear portion, the diameter-enlarged parts expanding outward in an axial direction and being configured to be spaced away from the stabilizer bar.

According to the stabilizer bushing structured following the present preferred embodiment, for example, when the inner circumferential surface of the bushing body is pressed against the stabilizer bar and the radially inner end of the bushing body deforms to bulge outward in the axial direction, the bulging portion is housed inside the diameter-enlarged parts, and the axial end face of the bushing body is prevented from protruding excessively.

In the present preferred embodiment, it is desirable that the axial convex surface of the pedestal member be formed with such an axial length as to extend from the linear portion of the bushing body to both axial sides and reach so far as the diameter-enlarged parts on both sides. Besides, it is desirable that the inside surface of the pedestal member comprise the axial convex surface for its entire axial length. With this configuration, the inside surface of the pedestal member is most remote from the stabilizer bar radially outward at both axial ends.

According to the present disclosure, it is possible to stably hold the stabilizer bar in position by adopting the pedestal member, and to achieve improvement in durability while preventing the spring characteristics in the prizing direction from excessively becoming harder.

### BRIEF DESCRIPTION OF THE DRAWINGS

The foregoing and/or other objects, features and advantages of the disclosure will become more apparent from the following description of practical embodiments with reference to the accompanying drawings in which like reference numerals designate like elements and wherein:

FIG. 1 is a perspective view showing a stabilizer bushing according to a first practical embodiment of the present disclosure;

FIG. 2 is a cross sectional view of the stabilizer bushing shown in FIG. 1, taken along line 2-2 of FIG. 3;

FIG. 3 is a cross sectional view taken along line 3-3 of FIG. 2;

FIG. 4 is a perspective view of a first member constituting the stabilizer bushing shown in FIG. 1;

FIG. 5 is a perspective view of a second member constituting the stabilizer bushing shown in FIG. 1;

FIG. 6 is a cross sectional view of the second member shown in FIG. 5, taken along line 6-6 of FIG. 7;

FIG. 7 is a cross sectional view taken along line 7-7 of FIG. 6;

FIG. 8 is a perspective view of a pedestal member constituting the second member shown in FIG. 5;

FIG. 9 is a plan view of the pedestal member shown in FIG. 8;

FIG. 10 is a cross sectional view of the pedestal member shown in FIG. 8, taken along line 10-10 of FIG. 11;

FIG. 11 is a cross sectional view taken along line 11-11 of FIG. 10;

FIG. 12 is a perspective view of the stabilizer bushing shown in FIG. 1 with a stabilizer bar and a bracket mounted; and

FIG. 13 is a cross sectional view of the stabilizer bushing shown in FIG. 1 in a mounted state onto a vehicle.

### DETAILED DESCRIPTION

Hereinafter, a practical embodiment of the present disclosure will be described with reference to the drawings.

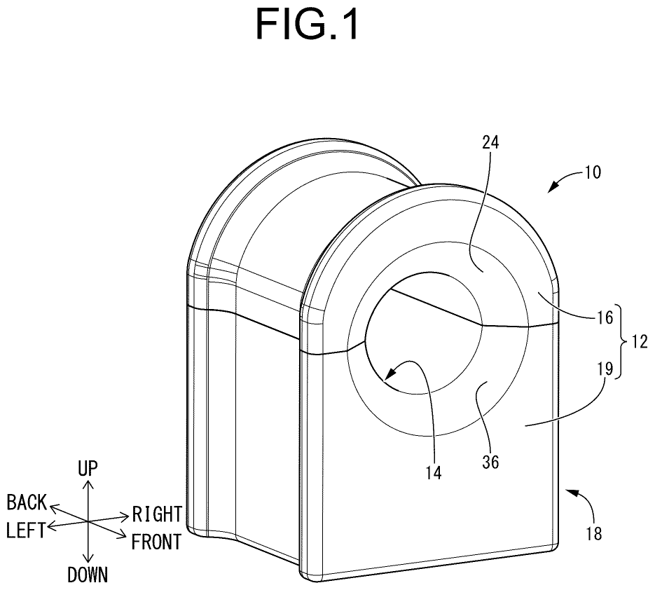

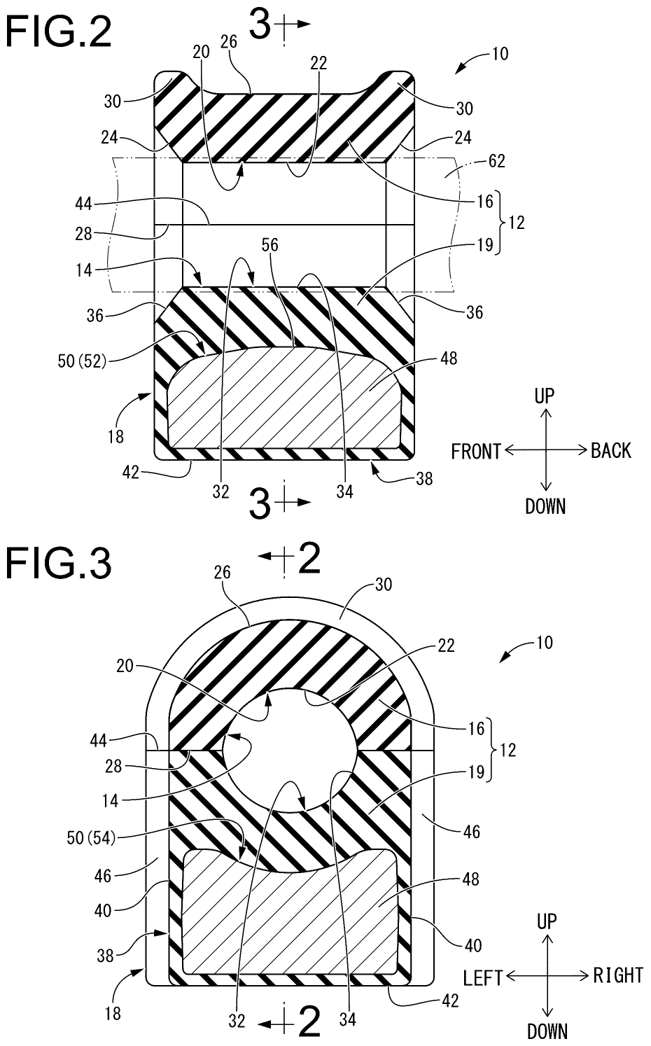

FIGS. 1 to 3 show a stabilizer bushing 10 according to a first practical embodiment of the present disclosure. The stabilizer bushing 10 includes a bushing body 12 formed of a rubber elastic body. In the following description, as a general rule, the vertical direction refers to the vertical direction in FIG. 2, the front-back direction refers to the left-right direction in FIG. 2, and the left-right direction refers to the left-right direction in FIG. 3.

The bushing body 12 is formed of a rubber elastic body, and has a tubular shape overall. An inner hole 14 perforates the bushing body 12 in the front-back direction. The bushing body 12 has a configuration of two divided sections comprising an opposite-side portion in the form of a first member 16 and an attachment-side portion in the form of an elastic body 19 of a second member 18, which are independent of each other.

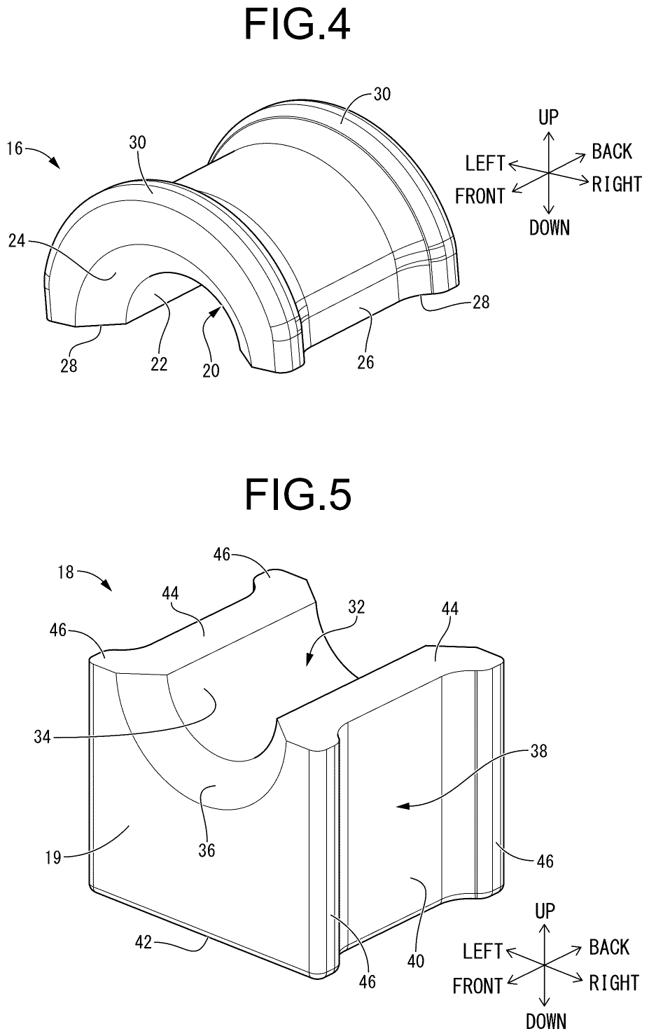

As shown in FIG. 4, the first member 16 has an approximately semi-cylindrical shape overall, and is entirely formed of a rubber elastic body. Described more specifically, a first inner circumferential surface 20, which is the inner circumferential surface of the first member 16, is a curved surface with an approximately arcuate cross section of less than half the circumference. As shown in FIG. 2, the middle portion of the first inner circumferential surface 20 in the front-back direction comprises a first linear portion 22 extending in the front-back direction with an approximately constant cross-sectional shape, and both front and back sides of the first linear portion 22 comprise first diameter-enlarged parts 24, 24 of tapered contours expanding outward in the front-back direction. The axial length dimension (La) of the first linear portion 22 is suitably half or more of the axial length of the first member 16, and more suitably not less than ⅔ thereof. A first outer peripheral surface 26, which is the outer peripheral surface of the first member 16, has an arcuate cross section in the middle portion in the peripheral direction and flat surfaces spreading approximately orthogonally to the left-right direction at both ends in the peripheral direction. First end faces 28, 28, which are the peripheral end faces of the first member 16, are flat surfaces spreading approximately orthogonally to the vertical direction, and are located on approximately the same plane.

First ridges 30 protruding radially outward are provided at both axial ends of the first member 16. As shown in FIG. 2, regarding the first ridges 30, the inner surfaces in the front-back direction of the proximal end portions slope toward the top outward in the front-back direction, and the outer surfaces in the front-back direction of the proximal end portions spread approximately orthogonally to the front-back direction, so that the first ridges 30 become narrower in the front-back direction toward the protruding distal ends. Besides, the distal end portions of the first ridges 30 become narrower in the front-back direction toward the protruding distal ends, and both front and back surfaces are curved surfaces.

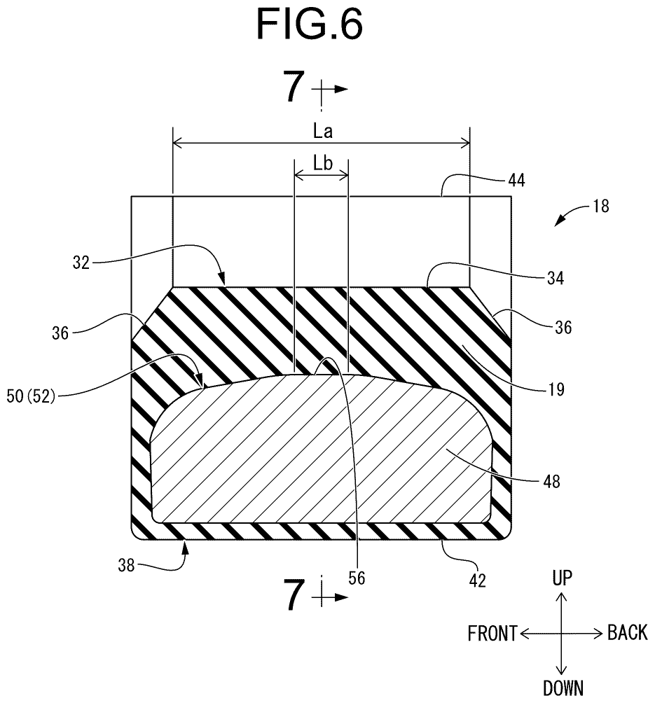

As shown in FIGS. 5 to 7, the second member 18 has an approximately semi-cylindrical shape overall. Described more specifically, a second inner circumferential surface 32, which is the inner circumferential surface of the second member 18, has an approximately arcuate cross section of less than half the circumference. As shown in FIGS. 2 and 6, the middle portion of the second inner circumferential surface 32 in the front-back direction comprises a second linear portion 34 extending in the front-back direction with an approximately constant cross-sectional shape, and both front and back sides of the second linear portion 34 comprise second diameter-enlarged parts 36, 36 of tapered contours expanding outward in the front-back direction. The axial length dimension (La) of the second linear portion 34 is suitably half or more of the axial length of the second member 18, and more suitably not less than ⅔ thereof. A second outer peripheral surface 38, which is the outer peripheral surface of the second member 18, is approximately rectangular as viewed in the front-back direction, and includes a left/right pair of side surfaces 40, 40 and a lower surface 42. The side surfaces 40, 40 and the lower surface 42 are all approximately rectangular surfaces, with the side surfaces 40, 40 spreading approximately orthogonally to the left-right direction and the lower surface 42 spreading approximately orthogonally to the vertical direction. Second end faces 44, 44, which are the peripheral end faces of the second member 18, are flat surfaces spreading approximately orthogonally to the vertical direction, and are located on approximately the same plane.

The side surfaces 40, 40 of the second member 18 are each provided with second ridges 46 projecting outward in the left-right direction. The second ridges 46 are respectively provided on both front and back end portions of each side surface 40, and extend straightly in a continuous fashion in the vertical direction with approximately the same cross-sectional shape as that of the first ridge 30.

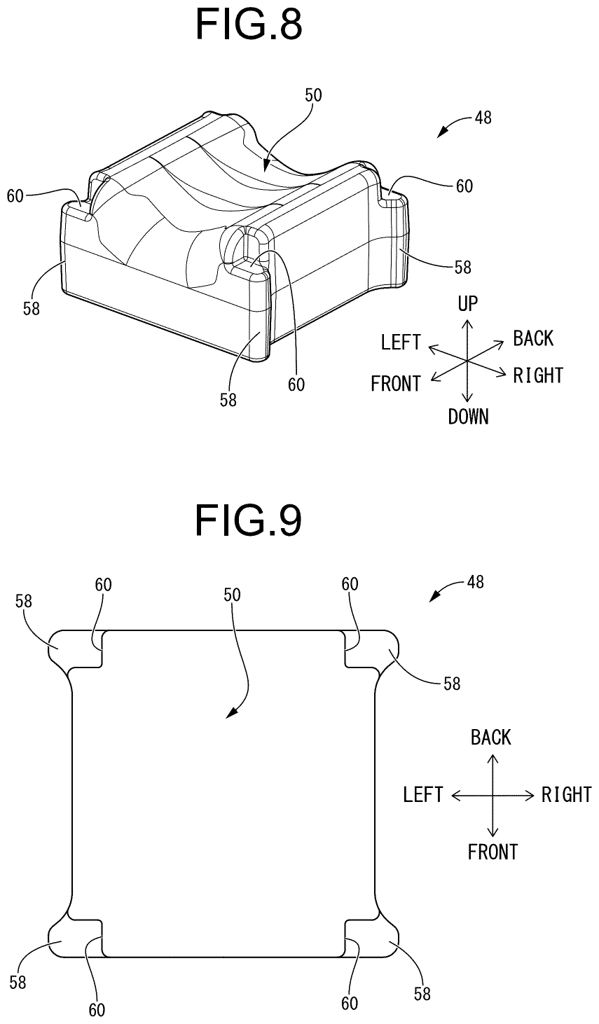

The second member 18 has a structure in which a pedestal member 48 is fastened in an embedded state to the elastic body 19 serving as the attachment-side portion constituting the bushing body 12. The pedestal member 48 is a rigid member formed of metal, synthetic resin, or the like, and has a shape of an approximately rectangular plate or rectangular block overall, as shown in FIGS. 8 to 11. Described more specifically, in the pedestal member 48, a lower surface is approximately a flat surface, and a pedestal upper surface 50, which is an inside surface, includes an axial convex surface 52 and a circumferential concave surface 54.

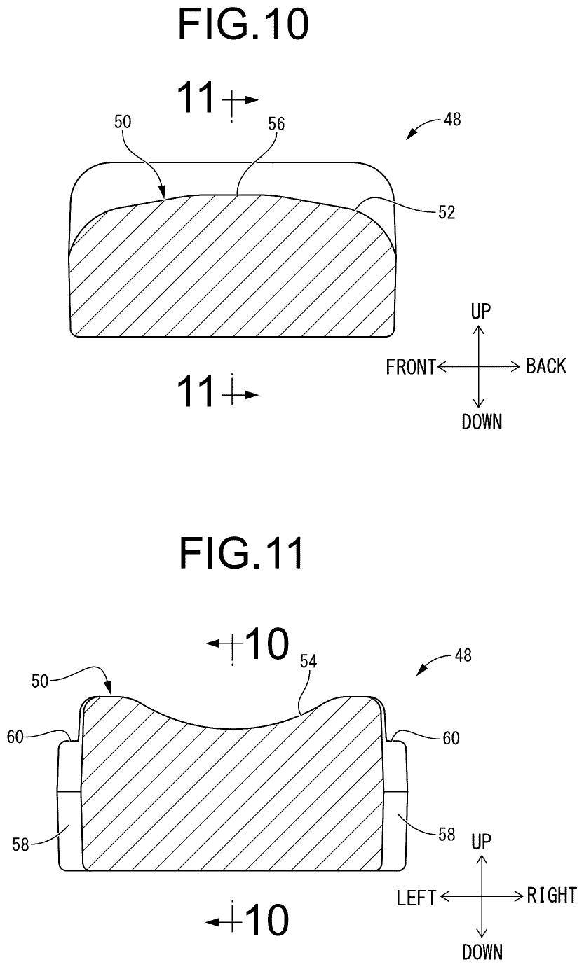

As shown in FIG. 10, the axial convex surface 52 has a convex longitudinal cross-sectional shape that protrudes upward, namely inward, more significantly toward the center from both ends in the front-back direction. The axial convex surface 52 of the present practical embodiment has a slope angle with respect to the axial direction that becomes smaller from both ends toward the center in the axial direction. The axial convex surface 52 of the present practical embodiment includes a straight portion 56 that extends in the axial direction with an approximately constant protrusion height at the axially center portion. The straight portion 56 extends without sloping with respect to the axial direction, and its axial length dimension Lb is suitably ¼ or less as large as the entire axial length of the axial convex surface 52. The axial length Lb of the straight portion 56 is suitably set within a range of 1/10 to ½ of the axial length La of the first and second linear portions 22, 34 of the bushing body 12 (see FIG. 6). Besides, the axial convex surface 52 of the present practical embodiment has an approximately constant slope angle with respect to the axial direction in the axially middle portion, and the slope angle gradually increases toward both outer sides in the axial direction at both axial end portions, so as to make the overall shape curved.

As shown in FIG. 11, the circumferential concave surface 54 is a curved surface with an arcuate cross section that curves in the circumferential direction. The circumferential concave surface 54 is provided in the middle portion of the pedestal upper surface 50 in the left-right direction, and its both end portions in the left-right direction are flat surfaces spreading approximately orthogonally to the vertical direction.

In the in top view of the pedestal member 48 shown in FIG. 9, the four corners are each provided with a protruding part 58 that projects outward in the left-right direction. In the protruding parts 58, the outer surface in the front-back direction spreads approximately orthogonally to the front-back direction, while the inner surface in the front-back direction slopes outward in the front-back direction toward the protruding distal end side, so as to have a tapered shape that become narrower in the front-back direction toward the protruding distal end. Besides, as shown in FIG. 8, the corner of the pedestal member 48 including the protruding part 58 includes a notched part 60 at the upper end, and the position of the upper surface is set lower than the other portions of the pedestal upper surface 50.

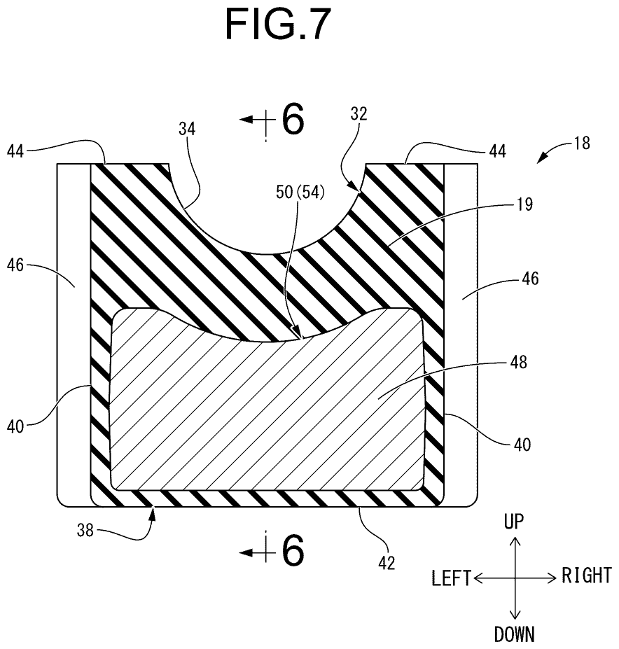

The pedestal member 48 of the above construction is arranged in a state of close contact with the elastic body 19, as shown in FIGS. 6 and 7. That is, the pedestal member 48 is fastened to the elastic body 19 in an embedded state, and the approximately entire surface of the pedestal member 48 is covered by the elastic body 19. In particular, the upper surface of the pedestal member 48 (the pedestal upper surface 50) constitutes the inside surface that is in close contact with the elastic body 19 throughout its entirety, and is not exposed to the outside. The pedestal member 48 is, for example, inserted during the vulcanization molding of the elastic body 19 and bonded by vulcanization to the elastic body 19.

The pedestal member 48 is disposed at a position shifted downward with respect to the elastic body 19, and is suitably disposed so as to be shifted downward in a portion of the elastic body 19 that is lower than the second inner circumferential surface 32. With this arrangement, in the elastic body 19, the thickness dimension of the portion covering the pedestal upper surface 50 is larger than the thickness dimension of the portion covering the lower surface of the pedestal member 48. Here, the pedestal member 48 is located approximately at the center with respect to the elastic body 19 in the front-back direction and in the left-right direction.

As shown in FIG. 6, the axial convex surface 52 of the pedestal member 48 reaches axially outer side with respect to the second linear portion 34 of the second inner circumferential surface 32, and reaches as far as the middle of the second diameter-enlarged part 36. In the present practical embodiment, the axial convex surface 52 extends outward in the front-back direction with respect to the center of the second diameter-enlarged part 36 in the front-back direction. The axial convex surface 52 protrudes with a shape that gradually curves inward (upward) toward the axial center from portions located on the radially outer side of both axial ends of the second linear portion 34, and the distance from the second linear portion 34 gradually increases outward in the front-back direction. Since both ends of the axial convex surface 52 with a large slope angle are located below the second diameter-enlarged parts 36, the distance between the axial convex surface 52 and the second diameter-enlarged parts 36 is reliably obtained at both front and back ends. Accordingly, the thickness dimension of the elastic body 19 covering the axial convex surface 52 is largely obtained at both ends in the front-back direction.

The distal end portions of the protruding parts 58 of the pedestal member 48 are fasten to the inside of the respective second ridges 46, and the downward deformation of the second ridges 46 due to mounting of a bracket 64 described later is suppressed by the protruding parts 58.

As shown in FIG. 7, the circumferential concave surface 54 of the pedestal member 48 is provided as far as the outer sides in the left-right direction with respect to the left and right ends of the second inner circumferential surface 32. This largely obtains the thickness dimension of the second member 18 covering the circumferential concave surface 54.

As shown in FIGS. 1 to 3, the first member 16 and the second member 18 are overlapped with each other in the vertical direction to form the stabilizer bushing 10. The first end faces 28, 28 of the first member 16 and the second end faces 44, 44 of the second member 18 are mutually overlapped in the vertical direction. Both the circumferential ends of each of the first ridges 30, 30 of the first member 16 and the respective upper ends of the second ridges 46, 46 of the second member 18 are mutually overlapped, so as to constitute the ridges continuously provided on the upper surface and both side surfaces of the stabilizer bushing 10.

The inner hole 14 passing in the front-back direction is formed between the first member 16 and the second member 18. The inner circumferential surface of the inner hole 14 is constituted by the first inner circumferential surface 20 and the second inner circumferential surface 32, and the inner hole 14 is a flat circular hole with the maximum inner diameter dimension in the vertical direction being smaller than the maximum inner diameter dimension in the left-right direction.

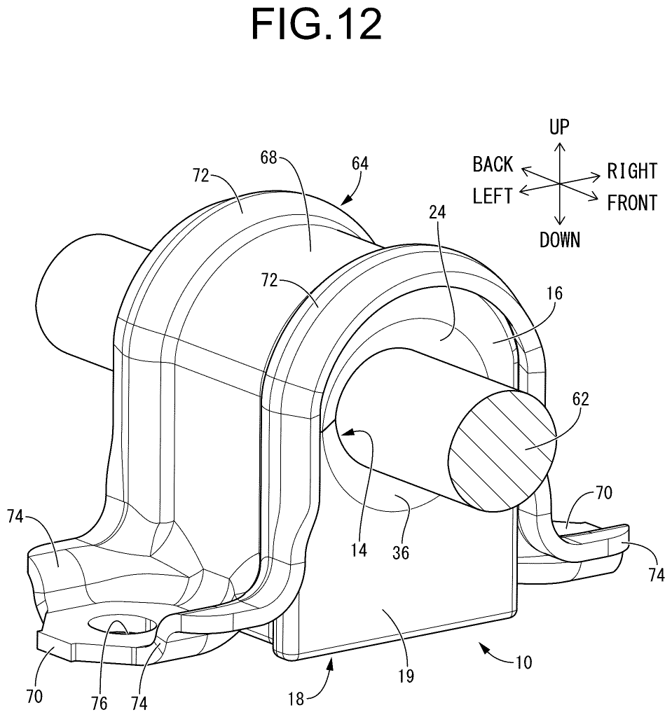

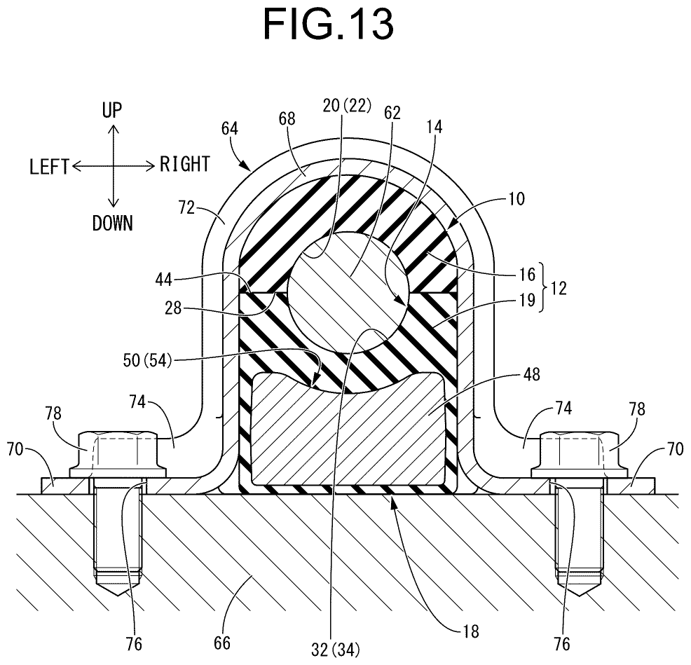

As shown in FIGS. 12 and 13, the stabilizer bushing 10 is mounted on a vehicle by a stabilizer bar 62 being inserted through the inner hole 14 while the bracket 64, which is overlapped on the outer peripheral surface, being attached to a vehicle body 66, thereby elastically holding the stabilizer bar 62 in position with respect to the vehicle body 66. The stabilizer bushing 10 of the present practical embodiment is arranged such that the mutually independent first member 16 and second member 18 clasp the stabilizer bar 62 from both upper and lower sides, and the first inner circumferential surface 20 of the first member 16 and the second inner circumferential surface 32 of the second member 18 are fastened to the outer circumferential surface of the stabilizer bar 62, whereby the stabilizer bushing 10 is constituted in a mounted state onto the stabilizer bar 62. By the stabilizer bushing 10 being constituted by the mutually independent first member 16 and second member 18 in this way, the manufacture of the first member 16 and the second member 18 is facilitated, and the stabilizer bushing 10 is readily mounted onto the stabilizer bar 62. Here, the stabilizer bushing 10 is mounted onto the stabilizer bar 62 with the first end faces 28, 28 of the first member 16 and the second end faces 44, 44 of the second member 18 being mutually overlapped, and those first end faces 28, 28 and second end faces 44, 44 may be mutually bonded.

The outer diameter dimension of the stabilizer bar 62 is larger than the maximum inner diameter dimension of the inner hole 14 in the vertical direction, and when the stabilizer bar 62 is inserted through the inner hole 14, the inner hole 14 of the bushing body 12 is pushed to expand in the vertical direction. By so doing, both the upper and lower portions of the inner hole 14 in the bushing body 12 are compressed in the vertical direction, and the inner circumferential surfaces 20, 32 of the bushing body 12 is in close contact with the outer circumferential surface of the stabilizer bar 62. In the present practical embodiment, the outer circumferential surface of the stabilizer bar 62 is fastened to the first and second linear portions 22, 34 of the bushing body 12 in a state of close contact, and the first and second linear portions 22, 34 comprise fastening surfaces with respect to the stabilizer bar 62. By the bushing body 12 being fastened to the stabilizer bar 62 at the first and second linear portions 22, 34 in this way, the stabilizer bushing 10 is stably mounted onto the stabilizer bar 62. The stabilizer bar 62 is placed between the first inner circumferential surface 20 and the second inner circumferential surface 32 when the first member 16 and the second member 18 are mutually combined, so as to be inserted through the inner hole 14 of the stabilizer bushing 10. In the present practical embodiment, the stabilizer bar 62 is bonded to the inner circumferential surface of the inner hole 14 (the first and second linear portions 22, 34).

When the first and second linear portions 22, 34 of the bushing body 12 are fastened to the outer circumferential surface of the stabilizer bar 62, the radially inner end of the bushing body 12 is pressed against the stabilizer bar 62, thereby deforming so as to bulge outward in the axial direction. Therefore, the first and second diameter-enlarged parts 24, 36 are provided on both axial sides of the respective first and second linear portions 22, 34 of the bushing body 12. With this configuration, the radially inner end of the bushing body 12 that bulges outward in the axial direction is housed within the first and second diameter-enlarged parts 24, 36, thereby being prevented from protruding outward in the axial direction. The radially inner end of the bushing body 12 is overlapped with the stabilizer bar 62 at the portion bulging outward in the axial direction as well, so that the mounting area of the bushing body 12 onto the stabilizer bar 62 is widely obtained.

The bracket 64 is a band plate-shaped member made of metal or the like, and is integrally equipped with a groove-shaped bushing mounting part 68 opening downward, and attachment pieces 70, 70 extending outward in the left-right direction from both ends of the bushing mounting part 68. Both front and back ends of the bushing mounting part 68 constitute groove-shaped parts 72 that correspond to the first ridges 30, 30 and the second ridges 46, 46 of the bushing body 12, and have a concave cross section opening radially inward, while protruding radially outward. Besides, at both front and back ends of the attachment piece 70, reinforcing ribs 74 protruding upward are provided continuously with the groove-shaped part 72 in the circumferential direction. The groove-shaped parts 72, 72 and the reinforcing ribs 74, 74 increase the deformation rigidity of the bracket 64 having a band plate shape.

As shown in FIG. 13, the bracket 64 is fixed to the vehicle body 66 by the attachment pieces 70, 70 being overlapped on the vehicle body 66 and by bolts 78, which are inserted through bolt holes 76 penetrating the respective attachment pieces 70, being screwed onto the vehicle body 66. The stabilizer bushing 10, which is externally mounted onto the stabilizer bar 62, is attached to the vehicle body 66 by being sandwiched in the vertical direction between the bushing mounting part 68 of the bracket 64 and the vehicle body 66. With this arrangement, the stabilizer bar 62 is supported and elastically held in position with respect to the vehicle body 66 via the stabilizer bushing 10. With the stabilizer bushing 10 mounted onto the vehicle, the first member 16 is interposed between the stabilizer bar 62 and the bracket 64, and the second member 18 is interposed between the stabilizer bar 62 and the vehicle body 66, so as to be attached to the vehicle body 66 side.

With the stabilizer bushing 10 mounted onto the vehicle in this way, the pedestal member 48 is disposed between the stabilizer bar 62 and the vehicle body 66 in the vertical direction. This allows the volume (the thickness dimension in the vertical direction) of the bushing body 12 interposed between the stabilizer bar 62 and the vehicle body 66 to be adjusted while appropriately setting the vertical position of the inner hole 14, through which the stabilizer bar 62 is inserted, with respect to the vehicle body 66. Thus, by setting the shape and the size of the pedestal member 48 appropriately, the spring characteristics of the stabilizer bushing 10 in the vertical direction can be tuned with a large degree of freedom.

That is, the pedestal upper surface 50 of the pedestal member 48 includes the axial convex surface 52 whose upward protrusion height dimension increases toward the axial center. With this configuration, the vertical thickness dimension of the bushing body 12 interposed between the stabilizer bar 62 and the vehicle body 66 is reduced at the axially center portion, and the spring of the stabilizer bushing 10 in the vertical direction can be set harder. This makes it possible to stably hold the stabilizer bar 62 in position with respect to the vehicle body 66, and improvement in durability is also achieved by deformation of the bushing body 12 being limited.

The thickness dimension of the bushing body 12 at the portion covering the axial convex surface 52 is set larger at both ends in the front-back direction. With this configuration, the spring of the bushing body 12 due to compression/tension between the stabilizer bar 62 and the pedestal member 48 is lowered at both ends in the front-back direction when the stabilizer bar 62 undergoes prizing displacement with respect to the vehicle body 66 in the vertical direction. Accordingly, soft spring characteristics are realized with respect to input in the prizing direction, and the ride comfort of the vehicle can be improved.

Besides, the pedestal upper surface 50 of the pedestal member 48 includes the circumferential concave surface 54, and the thickness dimension of the bushing body 12 is reliably obtained about the entire circumference of the stabilizer bar 62 without being locally reduced. With this configuration, upon torsional displacement of the stabilizer bar 62 in the circumferential direction, the spring constant of the bushing body 12 is lowered, and soft spring characteristics with respect to torsion of the stabilizer bar 62 are realized, thereby achieving a good comfort of the vehicle.

As described above, the stabilizer bushing 10 adopts the pedestal member 48 whose pedestal upper surface 50 includes the axial convex surface 52 and the circumferential concave surface 54. Thus, the stabilizer bushing 10 can achieve low spring characteristics in the prizing direction and in the torsional direction while increasing the spring rigidity in the vertical direction.

In the present practical embodiment, the straight portion 56 extending in the axial direction with an approximately constant protrusion height is provided at the axially center portion of the axial convex surface 52. This allows the stabilizer bushing 10 to be stably mounted onto the stabilizer bar 62 at the straight portion 56. In addition, the bushing body 12 located between the vertically opposed faces of the stabilizer bar 62 and the pedestal member 48 is thin-walled across the entire length of the straight portion 56, so that hard spring characteristics in the vertical direction are more advantageously achieved. Besides, since the straight portion 56 is provided at the axially center portion, an adverse effect on the low spring characteristics in the prizing direction is suppressed.

In particular, the straight portion 56 of the present practical embodiment has the axial length set within the range of 1/10 to ½ with respect to the first and second linear portions 22, 34 of the bushing body 12. Thus, hard spring characteristics in the vertical direction and soft spring characteristics in the vertical prizing direction are compatibly achieved in a good balance.

A practical embodiment of the present disclosure has been described in detail above, but the present disclosure is not limited to those specific descriptions. For example, the axial convex surface 52 need not necessarily be provided across the entire axial length of the pedestal member 48, but is acceptable as long as it is provided across the entire length of the portion in the pedestal member 48 located on the radially outer side of the first and second linear portions 22, 34 of the bushing body 12. That is, in the preceding practical embodiment, the portion of the pedestal member 48 that is off the first and second linear portions 22, 34 outward in the axial direction, in other words, the portion of the pedestal member 48 located on the radially outer side of the first and second diameter-enlarged parts 24, 36 of the bushing body 12 need not be provided with the axial convex surface 52.

In the first and second inner circumferential surfaces 20, 32 of the bushing body 12, the first and second diameter-enlarged parts 24, 36 are not essential. The first and second linear portions 22, 34 may be provided across the entire axial length of the first and second inner circumferential surfaces 20, 32. In this case, the pedestal upper surface 50 is located on the radially outer side of the first and second linear portions 22, 34 across the entire axial length, so that the axial convex surface 52 is provided across the entire axial length of the pedestal upper surface 50.

The straight portion 56 may be omitted from the axially center portion of the axial convex surface 52. For example, the inward protrusion height of the axial convex surface 52 may vary across the entire axial length.

The axial convex surface 52 may be a smooth convex curved surface, or may comprise a surface that has a polygonal line-shaped longitudinal cross section.

The size, shape, arrangement, and the like of the pedestal member 48 shown in the preceding practical embodiment, such as the size of the pedestal member 48 relative to the attachment-side portion of the bushing body 12 (the elastic body 19), the outer peripheral configuration of the pedestal member 48, the distance from the inner hole 14 to the pedestal member 48, the slope angle of the axial convex surface 52 in the axial direction, the curvature of the circumferential concave surface 54 in the circumferential direction, and the like are examples only and may be changed appropriately.

The attachment-side portion (the elastic body 19 of the second member 18) and the opposite-side portion (the first member 16) of the bushing body 12 may be integrally formed without being mutually independent. In this case, for example, a slit may be formed in a part of the circumferential wall of the inner hole 14, so that the stabilizer bar 62 can be inserted into the inner hole 14 through the slit.

The bushing body 12 need not be bonded to the outer circumferential surface of the stabilizer bar 62, but may be attached to the stabilizer bar 62 by being in close contact with the outer circumferential surface of the stabilizer bar 62 without being bonded thereto.

What is claimed is:

1. A stabilizer bushing configured to elastically hold a stabilizer bar in position in a vehicle, comprising:
a bushing body comprising a tubular elastic body, the bushing body including a linear portion on an inner circumferential surface, the linear portion being configured to be in close contact with an outer circumferential surface of the stabilizer bar; and
a rigid pedestal member arranged in an attachment-side portion of the bushing body, the attachment-side portion being configured to be attached to a vehicle body side, wherein
an inside surface of the rigid pedestal member that is in close contact with the bushing body comprises:
an axial convex surface protruding gradually inward from both axial ends toward an axial center across an entire axial length in a portion located on a radially outer side of the linear portion; and
a circumferential concave surface curving in a circumferential direction.

2. The stabilizer bushing according to claim 1, wherein
the axial convex surface protrudes with a shape that gradually curves inward toward the axial center from portions located on the radially outer side of both axial ends of the linear portion of the bushing body, and
the axial convex surface includes a straight portion at an axially center portion, the straight portion extending in an axial direction with a constant protrusion height.

3. The stabilizer bushing according to claim 2, wherein
an axial length of the straight portion is set within a range of 1/10 to ½ of that of the linear portion.

4. The stabilizer bushing according to claim 1, wherein the bushing body has a configuration of two divided sections comprising:
the attachment-side portion configured to be attached to the vehicle body side; and
an opposite-side portion arranged opposite to and overlapped with the attachment-side portion in an axis-perpendicular direction.

5. The stabilizer bushing according to claim 1, wherein the linear portion of the inner circumferential surface of the bushing body comprises a fastening surface configured to be fastened to the stabilizer bar.

6. The stabilizer bushing according to claim 1, wherein the inner circumferential surface of the bushing body includes diameter-enlarged parts on both axial sides of the linear portion, the diameter-enlarged parts expanding outward in an axial direction and being configured to be spaced away from the stabilizer bar.
